(19) United States
(12) Patent Application Publication
(10) Pub. No.: US 2025/0097355 A1
(43) Pub. Date: Mar. 20, 2025

(54) SYSTEM AND METHOD FOR ASSISTED IMPORTATION OF DEVICES TO A CLOUD SERVICE

(71) Applicant: Toshiba TEC Kabushiki Kaisha, Shinagawa-ku (JP)

(72) Inventor: Ryan S. Johnson, Buena Park, CA (US)

(21) Appl. No.: 18/368,651

(22) Filed: Sep. 15, 2023

(51) Int. Cl. H04N 1/00

(52) U.S. Cl. CPC H04N 1/00217; H04N 1/00244; H04N 2201/0094

(57) ABSTRACT

A system and method for assisted onboarding of multifunction peripherals to a cloud device management system uses a smartphone or tablet to commence a new device registration. A user determines whether to register using device information obtained directly via near field communication (NFC), if available, or via decoding a QR code output by the MFP. When NFC is used, the smartphone links to the MFP and downloads the device information. When QR codes are used, the smartphone scans the code and decodes it to get the device information. Device handshaking between the MFP and the cloud service is commenced by sending an instruction from the smartphone to the MFP for NFC registration, and by showing user instructions for commencing handshaking on the smartphone display when QR code registration is used.

### TECHNICAL FIELD OF THE INVENTION

This application relates generally to document processing device management. The application relates more particularly to a mobile data device configured to assist in importing individual multifunction peripherals into a cloud service platform for management and maintenance.

### BACKGROUND OF THE INVENTION

Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFPs are understood to comprise printers, alone or in combination with other of the afore-noted functions. It is further understood that any suitable document processing device can be used.

The history of managing MFPs has evolved significantly over the years. Initially, MFPs were managed manually on local networks. In the early 2000s, remote management through web interfaces became possible. A transformation began in the mid-2010s when cloud-based solutions emerged, simplifying MFP configuration and maintenance. Manufacturers began integrated cloud connectivity, and managed print services (MPS) providers started offering cloud-based fleet management. Cloud-enabled MFPs also embraced IoT (Internet of Things) and data analytics, leading to insights on usage and performance.

### BRIEF DESCRIPTION OF THE DRAWINGS

Various embodiments will become better understood with regard to the following description, appended claims and accompanying drawings wherein:

FIG. 1 is an example embodiment of a system for assisted importation of devices to a cloud service;

FIG. 2 is an example embodiment of a networked digital device, such as a multifunction peripheral;

FIG. 3 is an example embodiment of a digital device system;

FIG. 4 illustrates an example embodiment of a system diagram for a system and method for assisted importation of devices to a cloud service; and

FIG. 5 is an example embodiment of a flowchart for a system for assisted importation of devices to a cloud service.

### DETAILED DESCRIPTION OF THE INVENTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

Example embodiments herein provide a way to quickly and easily add an MFP to a cloud management service. Successful registration involves some or all of the following details:

### Device Information:

Device Name/ID: A unique identifier for the MFP within the management system.

Manufacturer and Model: The make and model of the MFP.

Serial Number: The serial number of the MFP for precise identification.

### Network Configuration:

IP Address: The IP address of the MFP on the network.

Subnet Mask: Network subnet information.

Gateway: The gateway or router the MFP uses to access the internet or cloud services.

DNS Server: Domain Name System server information for network communication.

### Authentication Credentials:

Username and Password: Credentials required to access and manage the MFP remotely or through the cloud.

### Protocol and Ports:

Communication Protocol: Information about the communication protocol used by the MFP (e.g., HTTP, HTTPS, SNMP).

Port Numbers: Port numbers used for communication (e.g., port 80 for HTTP, port 443 for HTTPS).

### Cloud Service Account Details:

Account Credentials: Credentials for the cloud-based printer management system, which could include a username and password or API keys.

Service URL: The URL or endpoint for connecting to the cloud service.

### Security and Permissions:

Access Permissions: Define who can access and manage the MFP through the cloud system (e.g., administrators, users).

Security Settings: Configure security settings such as encryption, firewall rules, and access control lists.

### Location Information:

Physical Location: Information about where the MFP is located, which can be useful for managing multiple devices.

### Firmware and Software Versions:

Firmware Version: The current firmware version running on the MFP.

Driver/Software Version: The software or driver version used for MFP integration.

### Usage and Configuration Settings:

Default Settings: Any specific default settings or configurations required for the MFP to operate correctly.

Usage Parameters: Information about how the MFP will be used, such as printing, scanning, faxing, or copying.

### Maintenance and Support Information:

Warranty Information: Details about the MFP's warranty status, if applicable. Support Contacts: Contact information for technical support or maintenance services.

The exact information required may vary depending on the specific cloud-based management system in use.

In order to add a MFP device to a Cloud Management Service, an administrative user must obtain information about each individual device. This can require manually finding that information and entering it in, which takes up time, particularly when large fleets of MFPs are to be managed. Also, to finalize the registration, each MFP must sync with the Cloud Management Service to handshake. This is done either by a periodic check, which takes time, or a restart, which causes some downtime, and neither may be obvious to a user.

Data handshaking between Multi-Function Printers (MFPs) and a cloud management service refers to the process by which these devices establish a secure and synchronized connection to exchange information seamlessly. During this digital “handshake,” the MFPs transmit relevant data such as device status, usage statistics, error logs, and diagnostic information to the cloud service. This data enables real-time monitoring, remote management, and efficient troubleshooting by the cloud management service. Conversely, the cloud service may push updates, configuration changes, or print job requests to the MFPs. This bi-directional communication ensures that MFPs are optimally maintained, and users can enjoy a more streamlined and responsive printing and document management experience while also enabling proactive maintenance and resource allocation by the cloud service.

Example embodiments herein provide a system comprised of an MFP application (sometimes referred to as an App or an eApp), and a mobile app. The MFP app uses either visually encoded information, such as a QR code, or near field communication (NFC) to transfer registration information to the mobile app, in which the user can then register onto the Cloud Management Service under their name. NFC (Near Field Communication) data transfer is a short-range, contactless wireless communication method that allows devices to exchange data by simply bringing them close together.

The app then can either use NFC to send a command to the MFP to do a handshake with the Cloud Management Service or provide instruction to trigger the handshake manually, making it clear to a user on how to register the device.

This configuration makes use of QR codes and NFC to gather information needed for registration and automatically does so on behalf of the logged in user. This negates a need for the user to obtain and enter the information themselves into the Cloud Management Service. A device commences a handshake with the Cloud Management Service to commence management of the device by the Service. This configuration functions to either trigger a handshake automatically via an NFC command, or display instructions to the user on how to do it manually.

In an example embodiment, the system adds devices to a cloud management service by way of either QR Code or NFC. The user first logs in via an App on their mobile device and chooses to add a new device. The user is then prompted to select use between use of a QR code or NFC to add the device. This selection may depend on MFP capabilities, such as whether it has NFC functionality. Both methods suitably use a wireless data connection, such as cellular, WiFi, optical, or the like.

The mobile app then instructs the user on how to access a QR code for registration or how to prime the NFC signal via the MFP app. Both methods are used, either through the image or on the NFC, to transmit a file that contains all the information needed to add the device, such as serial number, model number or model name. This information is sent along with an add device request to the cloud management service to add that device to the management cloud. If it is successful, it gives an okay confirmation is sent by the cloud service to the mobile app. If it fails due to the device already having been added, or some other error, the process is stopped and the user is informed about the error.

If an add device operation via NFC is successful, the mobile app sends a command via NFC to the MFP app to trigger the handshake from the MFP to the cloud management service to fully activate the device on the cloud. The result is suitably shown to the user on the MFP screen. If the QR code was used, then the Mobile app shows instructions on how to navigate the MFP app to invoke the handshake.

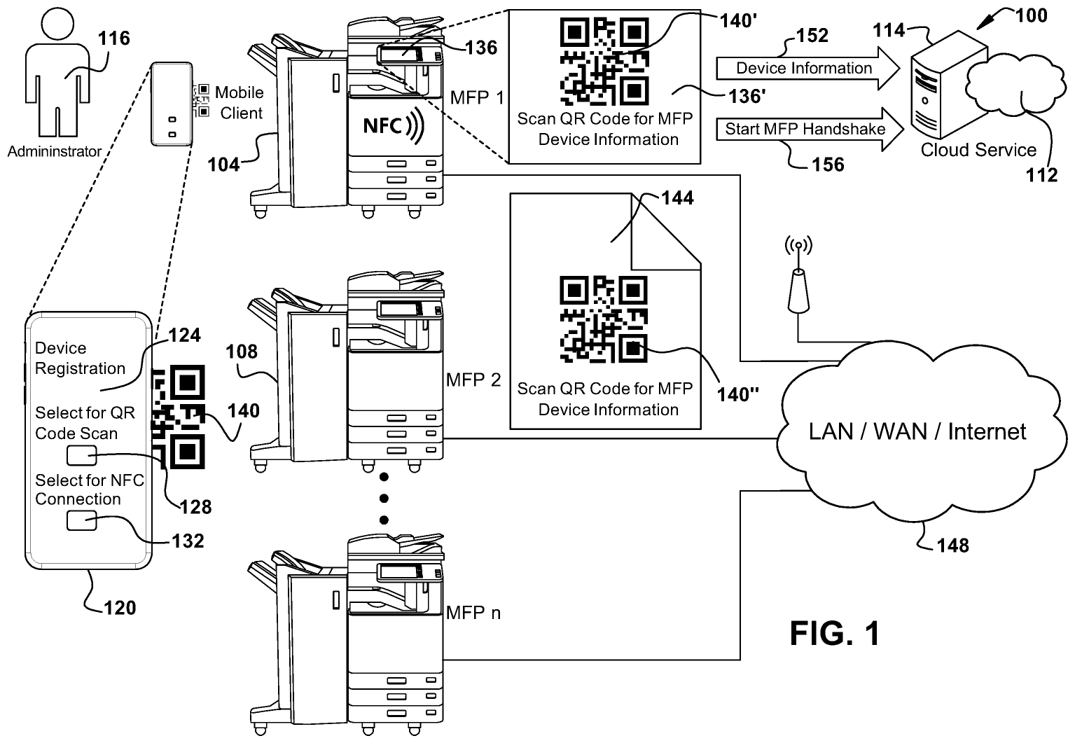

FIG. 1 illustrates an example embodiment of a system 100 for assisted importation of devices to a cloud service. In the example, one or more MFPs, such as MFP 104 and MFP 108 are targeted for registration for management by cloud service 112 utilizing cloud server 114. Administrative user 116 commences registration on their portable data device, such as smartphone 120. A display shows a selectable indicia 128 to commence registration by use of a visually encoded indicia, suitably QR code 140, and selectable indicia 132 to commence wireless data registration, suitably via NFC. An MFP suitably displays its QR code encoding its device information on its display, such as display 136 on MFP 104. A blow up 136′ of display 136 shows QR code 140′ for scanning by smartphone 120. Alternatively, a QR code may be shown on a printout, such as QR code 140″ on printout 144 generated from MFP 108. Thus, device information 152 is relayed from smartphone 120, which also commences data handshake 156 automatically or manually, depending on whether NFC or QR data entry was used.

Devices in FIG. 1 are in data communication via network cloud 148, suitably comprised of a local area network (LAN), a wide area network (WAN), which may comprise the Internet, or any suitable combination thereof. Network cloud 148 is comprised of any suitable wireless or wired data connection or combination thereof and provides for data transfer between devices.

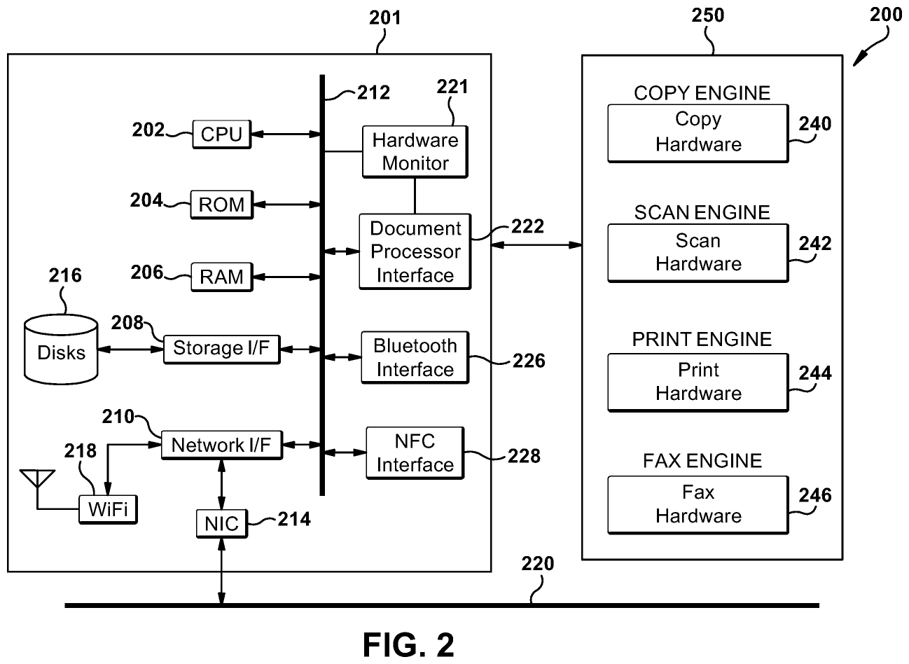

Turning now to FIG. 2, illustrated is an example embodiment of a networked digital device comprised of document rendering system 200 suitably comprised within an MFP, such as with MFPs 104 and 108 of FIG. 1. It will be appreciated that an MFP includes an intelligent controller 201 which is itself a computer system. Thus, an MFP can itself function as a server with the capabilities described herein. Included in intelligent controller 201 are one or more processors, such as that illustrated by processor (CPU) 202. Each processor is suitably associated with non-volatile memory, such as read-only memory (ROM) 204, and random access memory (RAM) 206, via a data bus 212.

Processor 202 is also in data communication with input/output interface, suitably comprising a user touchscreen. While touchscreens are discussed in example embodiments herein, it is to be appreciated that any suitable user interface, such as keyboards, switches, displays, trackballs or mice may be used.

Processor 202 is also in data communication with a storage interface 208 for reading or writing to a storage 216, suitably comprised of a hard disk, optical disk, solid-state disk, cloud-based storage, or any other suitable data storage as will be appreciated by one of ordinary skill in the art.

Processor 202 is also in data communication with additional interfaces, such as Bluetooth interface 226 and NFC interface 228.

Processor 202 is also in data communication with a network interface 210 which provides an interface to a network interface controller (NIC) 214, which in turn provides a data path to any suitable wired interface or physical network connection 220, or to a wireless data connection via wireless network interface 218. Example wireless network interfaces include optical, cellular, Wi-Fi, wireless universal serial bus (wireless USB), satellite, and the like. Example wired interfaces include Ethernet, USB, IEEE 1394 (FireWire), Lightning, telephone line, or the like.

Processor 202 can also be in data communication with any suitable user input/output (I/O) which provides data communication for interfacing with user peripherals, such as displays, keyboards, mice, track balls, touch screens, or the like. Processor 202 can also be in communication with hardware monitor 221, such as a page counter, temperature sensor, toner or ink level sensor, paper level sensor, or the like.

Also in data communication with data bus 212 is a document processor interface 222 suitable for data communication with the document rendering system 250, including MFP functional units. In the illustrated example, these units include a copy engine comprising copy hardware 240, a scan engine comprise of scan hardware 242, a print engine comprised of print hardware 244 and a fax engine comprised of fax hardware 246 which together comprise document rendering system 250. It will be understood that functional units are suitably comprised of intelligent units, including any suitable hardware or software platform.

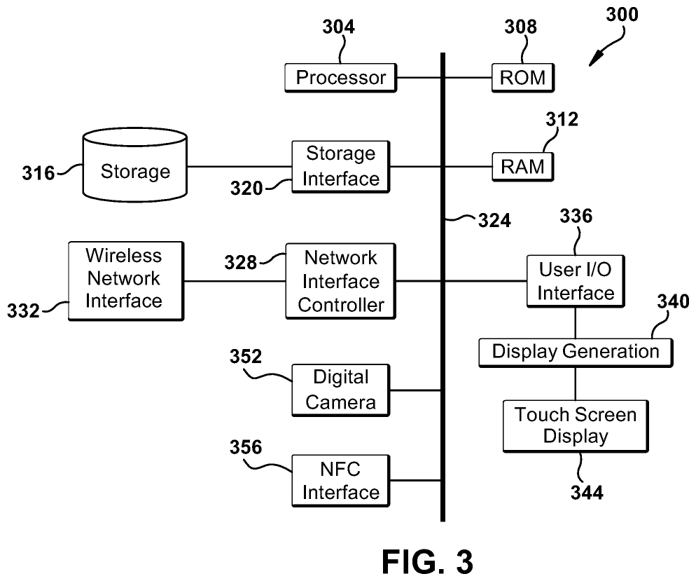

Turning now to FIG. 3, illustrated is an example embodiment of a digital data processing device 300 such as cloud server 114 and smartphone 120 of FIG. 1. It is to be appreciated that some components listed may be unnecessary in certain configurations. Components of the digital data processing device 300 suitably include one or more processors, illustrated by processor 304, memory, suitably comprised of read-only memory 308 and random access memory 312, and bulk or other non-volatile storage 316, suitably connected via a storage interface 320. Data communication among components is accomplished via data bus 324. A network interface controller 328 suitably provides a gateway for data communication with other devices, via any wireless or wired connection, such as via wireless network interface 332. A user input/output interface 336 is suitably comprised of display generator 340 interfacing with touchscreen display 344. As noted above, any suitable user input and display can be used. Processor 304 is also in data communication with an image capture device such as digital camera 352, suitably used to capture images which may include encoded images such as barcodes or QR codes.

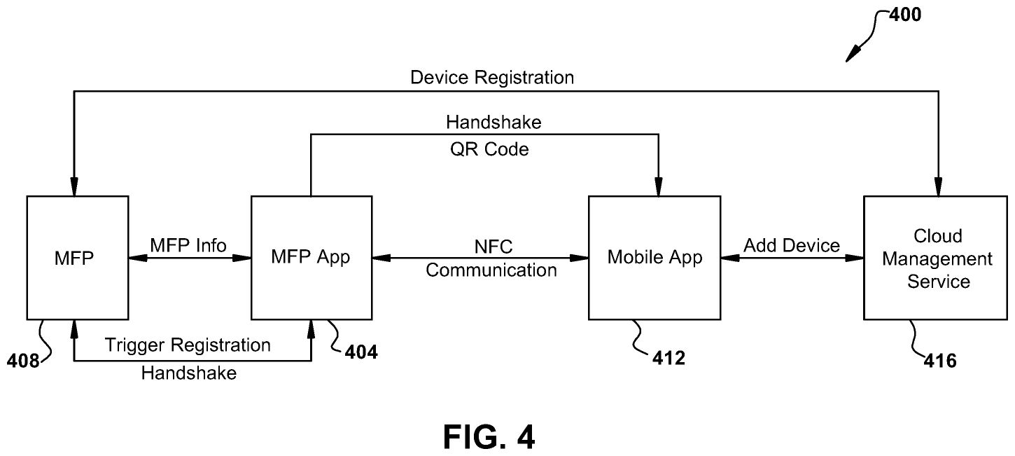

FIG. 4 illustrates an example embodiment of a system diagram 400 for a system and method for assisted importation of devices to a cloud service. In the illustration, MFP app 404, running on MFP 408, obtains MFP registration information. This information is relayed to mobile app 412 via QR code or NFC. The MFP is added to cloud management service 416 which then undertakes a registration handshake with MFP 408.

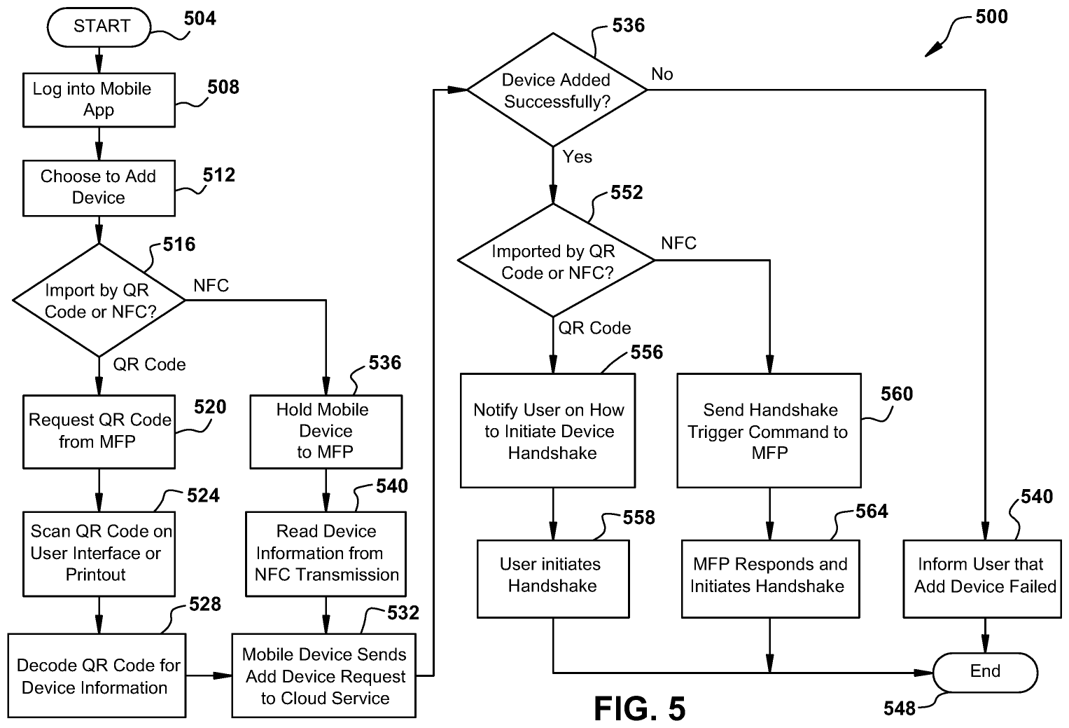

FIG. 5 illustrates an example embodiment of a flowchart 500 for a system for assisted importation of devices to a cloud service. The process commences at block 504 and proceeds to block 508 where a user logs into a device registration app on their mobile device. The user selects to add a device at block 512. The user decides at block 516 whether registration is to be undertaken via NFC or via QR code. When QR code registration is selected, the process proceeds to block 520 where a QR request is made to the MFP registration candidate. The resulting QR code is scanned by the mobile device at block 524 and decoded at block 528. The mobile device then adds the device and associated data at block 532.

If NFC registration is selected at block 516, the system proceeds to block 536 where the user places their mobile device proximate to the MFP wherein data is then read at block 540. The system then proceeds to block 532. A test is made at block 536 to determine whether the device was added successfully. If not, a message is generated at block 540 informing the user before the system ends at block 548.

If a device is determined to have been added successfully at block 536, a determination is made at block 552 if registration was via QR code or via NFC. If it was via NFC, the system proceeds to block 560 where a handshake trigger command is sent from the mobile device to the MFP at block 560. The MFP responds at block 564 and commences the handshake with the cloud management service. When QR code registration is determined at block 552, instructions for manual handshake initiation are displayed at block 556 and handshaking is initiated at block 558 before the system ends at block 548.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A system comprising:
a processor and associated memory;
a network interface;
a wireless data interface;
a digital imaging device; and
a user interface comprising a user input and a display;
wherein the processor is configured to,
receive a user selection to add an MFP to a cloud management system via the user interface,
receive a user data communication selection of peer-to-peer data communication with the MFP or visual data communication with the MFP,
receive device data from the MFP in accordance with the data communication selection,
send a device registration request for the MFP to an associated cloud management system in accordance with received device data via the network interface,
receive confirmation of a successful registration of the MFP with the associated cloud management system via the network interface, and
initiate a data exchange handshake between the MFP and the associated cloud management system after receipt of the confirmation.

2. The system of claim 1 wherein the processor is further configured to:
capture an image of encoded indicia via the digital imaging device and decode a captured image to generate the device data when visual data communication is selected; and
initiate peer-to-peer data communication with the MFP via the wireless data interface and receive the device data via the wireless data interface when peer-to-peer data communication is selected.

3. The system of claim 2 wherein the processor is further configured to:
show instructions on the display to initiate a data handshake between the MFP and the associated cloud management system when visual data communication is selected; and
send a handshake trigger instruction to the MFP via the wireless data interface when peer-to-peer data communication is selected.

4. The system of claim 3 wherein the wireless data interface is comprised of a NFC transceiver and wherein the digital imaging device is comprised of a camera.

5. The system of claim 4 further comprising encoded indicia comprised of a QR code or a barcode.

6. The system of claim 4 wherein the device data includes one or more of device model name, device model number, device serial number and network MAC address.

7. The system of claim 1 wherein the processor is further configured to show a message on the display when confirmation of the successful registration is not received.

8. A method comprising:
receiving a user selection to add an MFP to a cloud management system via a user interface of a digital data device;
receiving a user data communication selection of peer-to-peer data communication with the MFP or visual data communication with the MFP via the user interface;
receiving device data from the MFP in accordance with the data communication selection,
sending a device registration request for the MFP to an associated cloud management system in accordance with received device data via a network interface,
receive confirmation of a successful registration of the MFP with the associated cloud management system via the network interface, and
initiate a data exchange handshake between the MFP and the associated cloud management system after receipt of the confirmation.

9. The method of claim 8 further comprising:
capturing a digital image of encoded indicia via a digital imaging device and decoding the digital image to generate device data when visual data communication is selected; and
initiating peer-to-peer data communication with the MFP via a wireless data interface and receiving the device datavia the wireless data interface when peer-to-peer data communication is selected.

10. The method of claim 9 further comprising:
showing instructions on a display to initiate a data handshake between the MFP and the associated cloud management system when visual data communication is selected; and
sending a handshake trigger instruction to the MFP via the wireless data interface when peer-to-peer data communication is selected.

11. The method of claim 10 wherein the wireless data interface is comprised of a NFC transceiver and wherein the digital imaging device is comprised of a camera.

12. The method of claim 11 further comprising encoded indicia comprised of a QR code or a barcode.

13. The method of claim 12 wherein the device data includes one or more of device model name, device model number, device serial number and network MAC address.

14. The method of claim 13 further comprising showing a message on the display when confirmation of the successful registration is not received.

15. A non-transitory computer readable storage medium storing a program for causing a digital data device to execute a control method, the control method comprising:
receiving a user selection to add an MFP to a cloud management system via a user interface of a digital data device;
receiving a user data communication selection of peer-to-peer data communication with the MFP or visual data communication with the MFP via the user interface;
receiving device data from the MFP in accordance with the data communication selection,
sending a device registration request for the MFP to an associated cloud management system in accordance with received device data via a network interface,
receive confirmation of a successful registration of the MFP with the associated cloud management system via the network interface, and
initiate a data exchange handshake between the MFP and the associated cloud management system after receipt of the confirmation.

16. The non-transitory computer readable storage medium of claim 15 wherein the control method further comprises:
capturing a digital image of encoded indicia via a digital imaging device and decoding the digital image to generate device data when visual data communication is selected; and
initiating peer-to-peer data communication with the MFP via a wireless data interface and receiving the device data via the wireless data interface when peer-to-peer data communication is selected.

17. The non-transitory computer readable storage medium of claim 16 wherein the control method further comprises: showing instructions on a display to initiate a data handshake between the MFP and the associated cloud management system when visual data communication is selected; and
sending a handshake trigger instruction to the MFP via the wireless data interface when peer-to-peer data communication is selected.

18. The non-transitory computer readable storage medium of claim 17 wherein the wireless data interface is comprised of a NFC transceiver and wherein the digital imaging device is comprised of a camera.

19. The non-transitory computer readable storage medium of claim 18 wherein the control method further comprises encoded indicia comprised of a QR code or a barcode.

20. The non-transitory computer readable storage medium of claim 19 wherein the control method further comprises the device data includes one or more of device model name, device model number, device serial number and network MAC address.
